(19) United States
(12) Patent Application Publication
(10) Pub. No.: US 2011/0268498 A1
(43) Pub. Date: Nov. 3, 2011

(54) Universal Shaft Key and Repair Preform

(76) Inventor: Randall Robinson, Herndon, VA (US)

(21) Appl. No.: 12/771,227

(22) Filed: Apr. 30, 2010

(51) Int. Cl. F16B 7/00; B23P 17/04

(52) U.S. Cl. 403/356; 29/428

(57) ABSTRACT

A preform having a shape including a surface for bearing against a flatted shaft and a surface approximating the shape of a cylindrical portion of an exterior lateral surface of the shaft and having a protrusion thereon which is generally complementary to a keyway in a fixture to be attached to the shaft forms a universal substitute for conventional key and keyway joints between a shaft and a fixture. The joint formed using the preform is stronger, more robust and more resistant to damage and/or wear during use than a key and keyway joint while formation as a preform allows application to a wider variety of applications while facilitating repairs and allowing repairs to be performed in the field with easily portable hand or power tools.

### FIELD OF THE INVENTION

The present invention generally relates to affixing a fitting to a shaft where the fitting is rotationally positioned on the shaft using a key and keyway and, more particularly, to a preform for repair of such structures.

### BACKGROUND OF THE INVENTION

Many mechanical devices are known which involve a rotatable shaft and some fixture such as a lever, gear, pulley or cam attached to the shaft by which the shaft can be rotated and/or moved axially or the fitting can be moved by rotation and/or axial motion of the shaft. Unless the shaft and fixture are integrally formed, the structure is generally constituted by a fixture which is fitted onto the shaft axially and surrounds the shaft. In some cases, the fixture is formed in two pieces, divided through the aperture to accommodate the shaft, and the fixture reassembled around the shaft much in the manner of a clamp. Attachment to the shaft can then be achieved by an arrangement such as a so-called set screw which is driven against the shaft or by clamping of the fixture to the shaft in a manner which reduces a dimension (e.g. diameter) of an aperture in the fitting around the shaft.

However, the joint between the fixture and the shaft is inherently weak for carrying a force corresponding to rotation of the shaft and does not define a rotational positioning between the shaft and fitting which may be critical for synchronization with other parts of a mechanical apparatus of which the shaft and fitting may constitute a portion. Accordingly, a known and ubiquitous expedient for rotationally positioning a fixture on a shaft is a keyway on each of the fixture and shaft and a key which substantially fills the space defined by the respective keyways. A so-called Woodruff key is an example of a key and keyway shape which has been found advantageous for such a purpose and features a rounded surface on the key which cooperates with rounded surfaces in the keyway which may be formed by a simple grinding or machining process. Such an arrangement also provides the desirable effect of preventing or at least limiting axial motion of the key when in place with the assembled shaft and fitting while generally facilitating removal of the key from the keyway in the shaft when the fitting is removed from the shaft. Further, the particular configuration of a Woodruff key allows a relatively small number of keys of differing dimensions to satisfy requirements of the vast majority of machines likely to be used by the general public and most businesses and thus are commonly available as a common hardware commodity.

This expedient allows several additional functions to be achieved such as limiting the amount of force that can be transmitted between the fitting and the shaft by forming the key from a soft metal which can be sheared by excessive force in circumstances where the excessive force may be more critical than the position of the fixture on the shaft. Conversely, the key may be formed of a hard material or hardened (e.g. through heat treatment) where the position of the fitting on the shaft is particularly critical. However, the shaping of Woodruff keys and other styles of keys and keyways is not ideal since shear forces are not eliminated and forces are transmitted to and from the key through surfaces which are not perpendicular to the radial direction of the shaft. Thus, over time, due to small shifts and transfer of forces between the shaft and a fitting through the key and keyway, both the key and keyway, particularly the keyway formed in the shaft, can become deformed such that the key will not accurately position the fitting on the shaft or will be destroyed in a short time during normal operation of the mechanical device. When such deformation occurs, the keyway must be re=formed to properly receive a key. Such a repair involves cladding the surfaces of the deformed keyway by applying additional metal (sometimes of increased hardness) using a process similar to welding. Such a procedure requires specialized equipment and, due to the high temperatures involved, requires substantial care to avoid deformation of the shaft and/or fitting where the additional metal is deposited. Then, after depositing the additional metal, the deposited metal must then be machined to form surfaces against which a key can be properly seated. These operations generally require significant disassembly of the machine which, in addition to the specialized equipment required, is not amenable to field repairs. Additionally, the failure of a key/keyway structure may cause the machine to be substantially immobilized; preventing the machine from returning or being returned to a suitable repair facility under its own power or without additional equipment.

### SUMMARY OF THE INVENTION

It is therefore an object of the present invention to provide a structure which performs all functions of a key in positioning a fitting on a shaft but which is of an improved shape for distributing forces transferred between the shaft and fitting and which is thus more resistant to deformation during use and which can be retrofit to existing key/keyway joints.

It is another object of the invention to provide a repair preform for repairing deformed key/keyway structures which may be simply applied, using only portable tools and generally requiring only very limited machine disassembly, and which is thus capable of being applied as field repairs.

It is a further object of the invention to provide a repair preform allowing the number of different shapes and sizes required for most applications to be reduced.

In order to accomplish these and other objects of the invention, a preform for forming a joint between a shaft and a fixture to be mounted on said shaft is provided comprising a preform body having a surface for bearing against a flatted portion of a shaft, a curved surface approximating curvature of an outer surface of a portion of a cylinder and a protrusion from the curved surface approximately complementary to a keyway of a fixture.

In accordance with another aspect of the invention, a method of forming a joint between a shaft and a fixture, said fixture having an aperture generally complementary to said shaft and having a keyway on an inner surface of said aperture is provided comprising steps of forming a flatted surface on a shaft, placing a preform against the flatted surface, said preform including a preform body having a surface for bearing against a flatted portion of a shaft, a curved surface approximating curvature of an outer surface of a portion of a cylinder and a protrusion from the curved surface approximately complementary to a keyway of the fixture, and placing a fixture surrounding a portion of the shaft and a portion of the preform.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an exploded, perspective view of a conventional key/keyway joint employing a known Woodruff key,

FIGS. 2A and 2B are axial views illustrating exemplary failure modes of the conventional key/keyway joint of FIG. 1,

FIG. 3A is a perspective view of a preferred form of the invention,

FIG. 3B is an axial view of a shaft with the invention fitted thereon in a preferred manner,

FIG. 3C illustrates an optional variation of a shape of a portion of the invention,

FIG. 4 is an exploded perspective view of a joint between a shaft and fixture employing the invention,

FIGS. 5A, 5B and 5C are axial views of exemplary applications of the invention as a repair preform, and

FIG. 6 illustrates an optional perfecting feature of the invention which may enhance performance in some applications.

### DETAILED DESCRIPTION OF A PREFERRED EMBODIMENT OF THE INVENTION

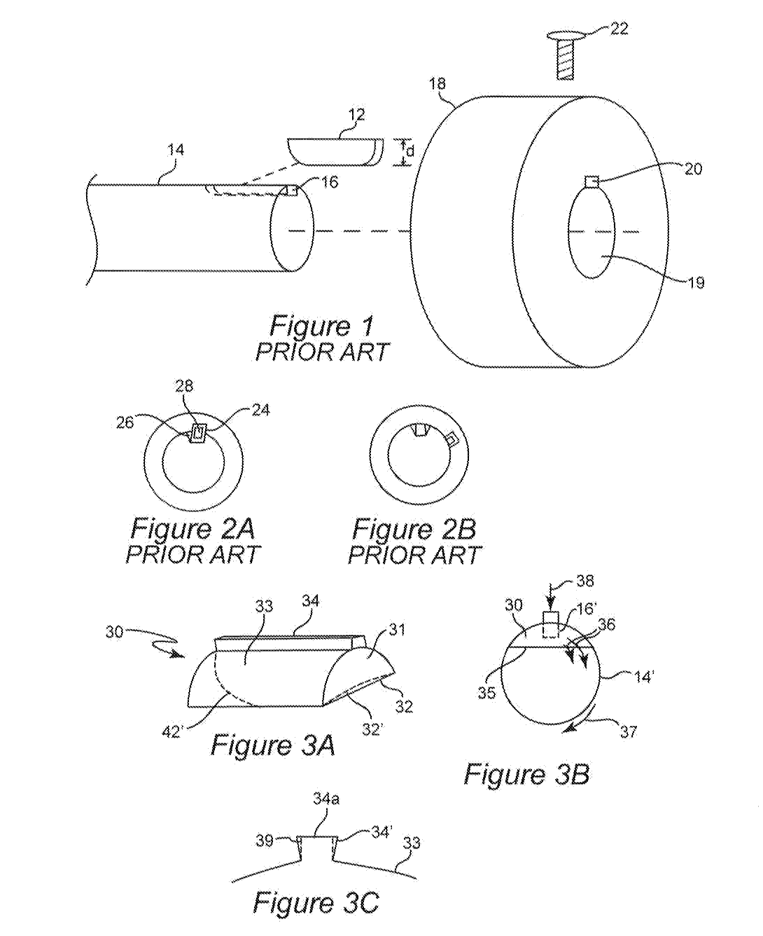

Referring now to the drawings, and more particularly to FIG. 1, there is shown an exploded perspective view of a conventional shaft to fitting joint using a conventional Woodruff key 12. For such a joint to be formed, shaft 14 is provided with a keyway 16 having a width to fit closely to Woodruff key 12 and a depth of approximately one-half of depth dimension, d, of Woodruff key 12 (hereinafter, more generally, simply “key” to comprehend keys of other designs) such that, when in place, key 12 protrudes from the shaft and provides surfaces extending substantially, but not precisely, in a radial direction relative to the shaft 14 (e.g. parallel to but spaced from a plane passing through the shaft axis). For clarity, keyway 16 is depicted as extending to the end of shaft 14 but it should be understood that extension of the shaft beyond the keyway or recessing of the keyway from the end of the shaft provides axial containment of the key, as is generally preferred. A generalized fitting is schematically depicted as a flange 18 having an aperture 19 of a size adequate to accommodate shaft 14 and fit closely thereto.

A further keyway 20 is formed within aperture 19 which is complementary to keyway 16 in shaft 14 of a width to similarly fit closely to key 12 and accommodate the portion of key 12 protruding from keyway 16 in shaft 14 (e.g. approximately the remaining one-half of dimension d). Thus, when these parts are assembled together, substantially the entire volume of aperture 19 and keyway 20 is occupied by shaft 14 and key 12 assembled into keyways 16, 20 and the assembly can be secured together using set screw 22 or some other expedient such that the interface between the shaft 14 and the surface of aperture 19 can transfer substantial force, in shear, between shaft 14 and flange/fitting 18. In such a condition, key 12 functions principally to locate flange/fitting 18 in a particular rotational position on shaft 14 and ideally carries little, if any, of the rotational force transferred between the shaft 14 and flange/fitting 18.

Inevitably and as a practical matter (and sometimes by design, as alluded to above when use of a soft metal key is intended), however, substantial force will be transferred between the shaft and flange through the key 12. Such transfer of force through key 12 can lead to a number of failure modes; exemplary ones of which are depicted in FIGS. 2A and 2B. In the failure mode depicted in FIG. 2A, a key is shown to have deformed to reduce its cross-sectional dimensions and/or to have deformed the keyways 16 and 20. Such deformation is largely due to the fact that forces bearing on the side surfaces of the key and keyway are not precisely perpendicular to the side surfaces of the key and keyway and are thus concentrated at corners 24, 26 of the respective keyways and at the center of the sides of the key 12. In such a failure mode, the fitting/flange 18 is no longer precisely positioned rotationally on shaft 14.

The failure mode illustrated in FIG. 2A, if not corrected (and which is not readily evident by simple inspection), will increase in severity, once initiated, and will generally result in the failure mode illustrated in FIG. 2B. In the failure mode of FIG. 2B, key 12 has sheared, as may be desirable in some applications where a soft metal is used in key 12, as alluded to above, where little, if any, damage to the keyways 16, 20 would be expected to have occurred. In such a case, it is generally possible to effect repairs by simply replacing key 12 which generally could be effected as field repair. However, in other cases, where shearing of the key upon excessive force being applied, substantial damage to the keyway 16, in particular, can be anticipated to have occurred and complex repairs, described above, which cannot generally be conducted as field repairs will be necessary to restore the shape of the keyway(s).

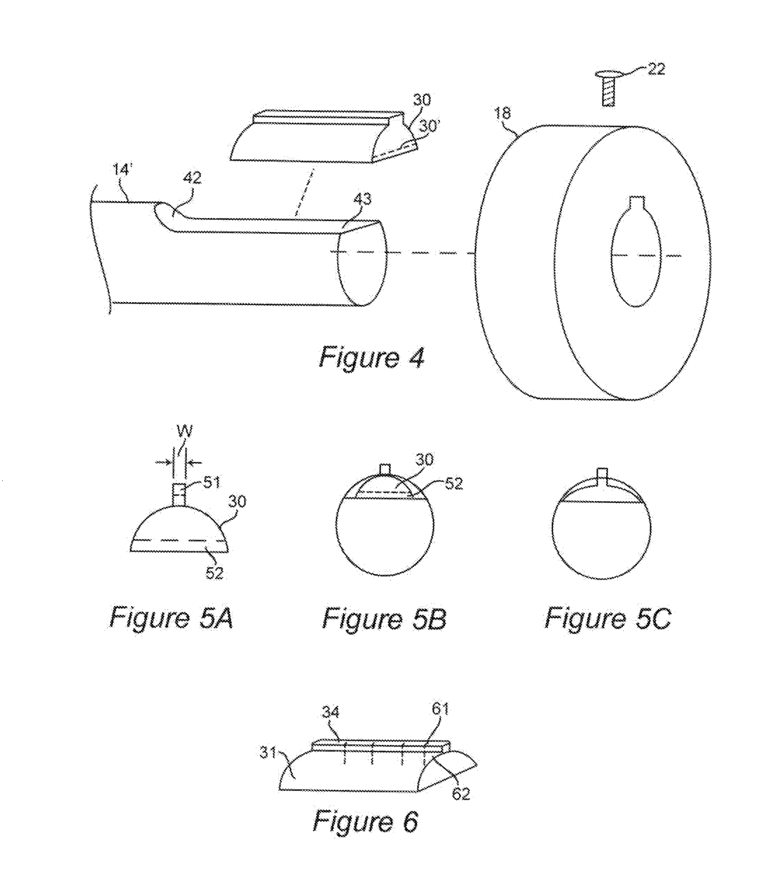

Referring now to FIG. 3A, a preform 30 in accordance with the invention is shown. Preform 30 comprises a body 31 of which one side is generally flat or slightly concave in shape or otherwise contoured to achieve a desired area of contact and distribution of forces as shown at 32, 32′, respectively. The opposing surface (upper surface as shown) 33 has a curved shape which is in the form of a portion of the surface of a cylinder and has a generally rectangular protrusion 34 which is approximately complementary to a keyway in a fixture (or, optionally, having a slightly “keystoned” shape as shown at 34′ of FIG. 3C as will be discussed in further detail below. This preform, in accordance with the invention is designed to cooperate with a flatted shaft 14′ when assembled in accordance with the exploded perspective view of FIG. 4 as illustrated in FIG. 3B.

Specifically, it is preferred that preform 30 be of a shape which substantially replaces material which would be removed from a shaft to form a flat bearing surface. It should be noted that while flatted shafts are occasionally used in non-critical shaft-to-fitting arrangements where a set screw or the like fastening device bears directly on the flatted surface, such joints are far from ideal since the removal of shaft material will destroy the rotational balance of the shaft and severely limit the forces which can be transferred. The force of the fastening device and possibly the forces being transferred can also cause distortion of the parts such that the shaft and flange/fitting are not coaxial as well as reducing bearing surfaces which concentrates forces and leads to damage and wear of either or both the flatted surface and fastening device and invariably causing loosening of the joint.

The invention, however, reduces and can (by choice of material or weighting) compensate for any rotational imbalance of the flatted shaft while providing a large bearing surface which serves to distribute forces transferred from the shaft to the flange/fitting through preform 30 as depicted by arrows 36 in FIG. 3B. It should be noted that while arrows 36 are depicted in a rotational direction concentric with shaft 14′, the actual force resulting from transferred force 37 will be, to some degree, more nearly perpendicular to surface 35 due to force 38 applied by a fastener such as set screw 22 as well as by confinement of the preform 30 within the aperture of a fitting. It should additionally be noted that the distribution of these forces can be adjusted by the (optional) slight concavity or curvature alluded to above and depicted at 32′ which may be provided initially on preform body 30 or applied when the preform body is installed on a flatted shaft as will be discussed: in greater detail below.

Preform 30 can be formed in numerous ways such as by casting or machining. Raised protrusion 34 serves to replace key 12 and can also be formed in numerous ways such as by integral casting or machining integrally with the remainder of the preform or applied separately by, for example, cladding and machining (which allows the remainder of the preform to be machined much more simply from shaft stock). Separate formation of protrusion 34 also allows various perfecting features to be incorporated such as choice of material for the protrusion (e.g. for strength, hardness or density to improve shaft balance, particularly in regard to forming a curved region 42 on the shaft adjacent the flatted surface 43 as shown in FIG. 4 to prevent concentration of forces and which may or may not be wholly or partially filled by preform 30 by contouring to form a complementary surface depicted by dashed line 42′) or heat treatment (e.g. for hardening, increasing elastic deformation before fracture, providing for shearing at a given force, pre-stressing the preform 30 adjacent and/or within the protrusion and the like, as may be desired, depending on the particular application). Alternatively, and as a perfecting feature of the invention which may be preferred for some applications, protrusion 34 may be formed separately from preform body 31 and affixed thereto with pins 61 such as expandable slotted tubes which may be, for example, interference fit into holes in the separate protrusion and shaft and/or by adhesion, soldering or brazing 62 or the like with a material having known or accurately determinable and/or controllable shear strength as illustrated in FIG. 6 when it is desired that the protrusion 34 be sheared away from preform body 31 at a given shear force.

It should be understood that protrusion 34 need not be substantially rectangular in cross-section but can be shaped in any desired fashion. Among shapes that could be employed, a slight “keystone” shape as illustrated in FIG. 3C could be employed that may be advantageous in some applications. Specifically, the sides of protrusion 34 may be formed with surfaces which may more closely approach or achieve a radial direction from the shaft axis such that the top surface 34a of protrusion 34 is wider than at the intersection with preform body 31. A small fillet shape 39 may be employed to reduce concentration of forces at the junction of protrusion 34 and preform body 31, if desired, and regardless of the shape of protrusion 34. Keyway 20 (FIG. 1) may also be relieved to be complementary to or otherwise accommodate such a fillet 39.

Such keystoning of protrusion 34 can provide several advantages in some applications of the invention. For example, as an original equipment part, the side surfaces are more nearly or could be exactly perpendicular to the direction of shear forces thus altering the distribution of compressional and/or shear forces against the side of the protrusion. Thus, by designing an appropriate angle for the sides of protrusion 34, the distribution of shear forces may be adjusted in accordance with the length of cantilever presented at any point along the sides of protrusion 34 to reduce a major cause of wear and damage inherent with conventional use of keys in key/keyway joints as discussed above in connections with FIG. 2A. Additionally or alternatively, when the preform of the invention is used in field repair applications, the additional material near surface 34a can compensate for wear or damage that enlarges keyway 20 but could be removed by simple abrasion (e.g. grinding, filing or the like) if not required for such a purpose.

In regard to use of the invention to facilitate field repairs which might not otherwise be possible, reference is again made to FIG. 3B. Assuming a failure mode such as those discussed above in connection with FIGS. 2A and/or 2B, field repairs utilizing the invention require only the formation of a generally flat portion or surface 43 on shaft 14. While Figure depicts, in the interest of clarity, the flatted surface extending to the end of the shaft, it should be understood that the flatted portion may be intermediate between cylindrical portions of the shaft. Such formation of flatted portion 43 will also have the advantage of serving to confine the preform against axial motion when in place on the shaft and surrounded by the aperture in the fixture. High accuracy is not required and such a generally flat surface adequate for repairs may be formed by grinding, filing or the like using the original keyway 16 as a guide as depicted by dashed line 16′ of FIG. 3B. The preform 30, in accordance with the invention can then be applied to the flat surface with or without further simple modification of the preform using easily portable power or manual tools and the fixture/flange 18 reassembled thereto to complete the repair.

As a further perfecting feature of the invention, not necessary to its successful practice in accordance with the most basic principles thereof, it is considered desirable to fabricate preform 30 with potentially excess material on the surface 32 and/or protrusion 34. Such potentially excess material can increase the generality of applicability of a single preform of a given size. As alluded to above, Woodruff keys are generally manufactured with shapes that are essentially standardized in two dimensions: width (in the direction of the width of the keyway) and height (in the direction of protrusion from the keyway). The length is usually scaled in accordance with one or both of these dimensions. Thus about seven to a dozen or so shapes and sizes of Woodruff keys are generally sufficient to most applications and are carried by hardware merchants as general replacement parts. Nevertheless, such inventory for even that small number of parts carries a significant cost in comparison with the small retail value of Woodruff keys themselves and relative infrequency of demand.

Referring now to FIG. 5A, a perfecting feature of the invention involves formation of preform body 30 with potentially excess material 51 in protrusion 34 potentially excess material 52 at surface 32. Such excess material can be chosen to be somewhat more easily removable by grinding, filing or the like than the remainder of preform 30 to further expedite field repairs. While it is preferable to use a preform in which surface 33 more or less exactly matches the curvature of the exterior of the shaft 14′ such a match is often not achievable with preforms which may be available or on hand for field repairs. However, in accordance with this perfecting feature of the invention, such a match, though preferable, is not necessarily required.

For example, as shown in FIG. 5B a preform intended for a smaller diameter shaft can be used on a larger shaft and fitting/flange aperture by leaving the entirety or a portion of potentially excess material 52 in place and removing excess material 51 from protrusion 34. Conversely, a preform intended for a larger shaft diameter can be used on a smaller shaft and aperture by leaving potentially excess material 51 in place and removing a sufficient amount of material 52 (and possibly some of the material of preform body 31 such that the width of surface 32 approximately matches the width of the flat 35 formed on shaft 14′). Either of these alternatives can include shaping or contouring surface 32 as shown, for example, at 32′ to control or adjust distribution of forces transferred between said preform and said shaft. In this latter regard, it should be appreciated that the material removed from shaft 14 to remove keyway damage may also be adjusted to achieve a match in widths of the flat and the preform surface as can usually be done without excessive weakening of the shaft. Thus, preforms in accordance with the invention need only be provided with dimensions scaled to the single parameter of keyway width, w, and the number of applications for which as many as a dozen or more Woodruff keys may be required may be answered, at least for purposes of temporary or field repair, by a much smaller number of standard protrusion widths (e.g. corresponding to four or five standard widths of Woodruff keys) which can also be modified, if necessary, by grinding, filing or the like which may be performed in the field using common and easily portable hand or power tools.

In view of the foregoing, it is clearly seen that the invention provides a substitute for a key and keyway joint capable of performing all functions thereof between a shaft and fixture that is superior to a conventional key and keyway joint in structure, force distribution, resistance to wear and damage, security against loosening, part size (e.g. to facilitate handling and reduce likelihood of loss under field repair conditions) as well as facilitating repair and enabling repair under field conditions and requiring, at most, material removal by grinding, filing or the like which can be performed with generally available and easily portable tools. The preform in accordance with the invention can be employed in original equipment or easily retrofit to existing equipment. Further, the vast majority of applications of joints between shafts and fixtures can be answered with a much reduced number of standardized preforms; reducing costs of inventory to suppliers and machine users alike.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A preform for forming a joint between a shaft and a fixture to be mounted on said shaft, said preform comprising
a preform body having a surface for bearing against a flatted portion of a shaft, a curved surface approximating curvature of an outer surface of a portion of a cylinder and
a protrusion from said curved surface approximately complementary to a keyway of said fixture.

2. A preform as recited in claim 1, wherein said surface for bearing against said flatted portion of said shaft is slightly concave.

3. A preform as recited in claim 1, wherein said surface for bearing against said flatted portion of said shaft is substantially flat.

4. A preform as recited in claim 1, wherein said surface for bearing against said flatted portion of said shaft is contoured too achieve a desired distribution of forces.

5. A preform as recited in claim 1 wherein said protrusion is substantially rectangular.

6. A preform as recited in claim 1 wherein said protrusion has a keystone shape.

7. A preform as recited in claim 1, wherein said protrusion is formed integrally with said preform.

8. A preform as recited in claim 1, wherein said protrusion is formed of material applied by cladding

9. A preform as recited in claim 1, wherein said protrusion is attached to said preform body with pins.

10. A preform as recited in claim 1 wherein said protrusion is attached to said preform body by at least one of adhesion, brazing or soldering.

11. A preform as recited in claim 1 wherein an end of said preform body is curved to be generally complementary to curvature adjacent to a flatted surface of a flatted shaft.

12. A method of forming a joint between a shaft and a fixture, said fixture having an aperture generally complementary to said shaft and having a keyway on an inner surface of said aperture, said method comprising steps of
forming a flatted surface on said shaft,
placing a preform against said flatted surface, said preform including
a preform body having a surface for bearing against a flatted portion of a shaft, a curved surface approximating curvature of an outer surface of a portion of a cylinder and
a protrusion from said curved surface approximately complementary to a keyway of said fixture, and
surrounding a portion of said shaft and a portion of said preform with said fixture.

13. A method as recited in claim 12, including the further step of
removing material from said protrusion.

14. A method as recited in claim 12, including the further step of
removing material from said preform body.

15. A method as recited in claim 12, wherein said step of forming a flatted surface on said shaft is performed in accordance with the location of a keyway on said shaft.

16. A method as recited in claim 12, including the further step of securing said fixture to said shaft and said preform by applying force to said protrusion.

17. A method as recited in claim 16, wherein said step of applying force to said protrusion is performed using a set screw.

18. A method as recited in claim 12, including the further step of contouring said flatted surface of said shaft and/or said surface for bearing against said flatted surface to control distribution of forces between said preform and said shaft.
